(19) United States
(12) Patent Application Publication
(10) Pub. No.: US 2010/0115225 A1
(43) Pub. Date: May 6, 2010

(54) Memory Device and Memory System Including the Same

(76) Inventors: Jaehong Kim, Seoul (KR); Heeseok Eun, Gyeonggi-do (KR); Yong June Kim, Seoul (KR); Seung-Hwan Song, Gyeonggi-do (KR)

Correspondence Address: MYERS BIGEL SIBLEY & SAJOVEC, PO BOX 37428, RALEIGH, NC, 27627, US

(21) Appl. No.: 12/577,842

(22) Filed: Oct. 13, 2009

(30) Foreign Application Priority Data
Nov. 6, 2008 (KR) 2008-109859

(51) Int. Cl. G06F 12/00

(52) U.S. Cl. 711/172; 711/E12.001

(57) ABSTRACT

Provided is a memory device. The memory device includes a word line and a plurality of memory cells connected to the word line. The plurality of memory cells forms a page, and the number of sectors configuring the page and the size of each of the sectors can be changed.

### REFERENCE TO PRIORITY APPLICATION

This U.S. application claims priority to Korean Patent Application 10-2008-0109859, filed Nov. 6, 2008, the contents of which are hereby incorporated herein by reference.

### FIELD OF THE INVENTION

The present invention relates to a memory device and a memory system including the same.

### BACKGROUND

A semiconductor memory device is a storage device that stores data and reads the data if necessary. The semiconductor memory device is largely classified into a volatile memory device and a nonvolatile memory device.

The volatile memory device is a memory device which loses stored data when power source is interrupted. The volatile memory device includes a Static Random Access Memory (SRAM), a Dynamic Random Access Memory (DRAM), and a Synchronous DRAM (SDRAM). The nonvolatile memory device is a memory device which holds stored data even when power source is interrupted. The nonvolatile memory device includes a Read Only Memory (ROM), a Programmable ROM (PROM), an Erasable PROM (EPROM), an Electrically EPROM (EEPROM), a flash memory device, a Parameter RAM (PRAM), a Magnetoresistive RAM (MRAM), a Resistive RAM (RRAM), and a Ferroelectric RAM (FRAM). The flash memory device is largely divided into a NOR type flash memory and a NAND type flash memory.

### SUMMARY OF THE INVENTION

The present invention is directed to a memory device capable of improving reliability and data storage efficiency.

An aspect of the present invention is to provide a memory device including: word lines; and a plurality of memory cells connected to the word lines, wherein the plurality of memory cells forms a page, and wherein the number of sectors configuring the page and the size of each of the sectors are changed.

According to another aspect of the present invention, the memory device and the controller may configure one semiconductor device.

### BRIEF DESCRIPTION OF THE DRAWINGS

FIG. 1 is a block diagram of a memory system according to an embodiment of the present invention;

FIG. 2 is a block diagram of a memory device of FIG. 1;

FIG. 3 is a diagram illustrating a threshold voltage distribution of memory cells which stores two data bits per cell;

FIGS. 4 to 7 are diagrams illustrating a method of storing sectors according to a first embodiment of the present invention;

FIG. 8 is a diagram illustrating a method of storing sectors according to a second embodiment of the present invention;

FIG. 9 is a diagram of a case where data and parity are stored in separate storage regions;

FIG. 10 is a block diagram illustrating an embodiment of a computing system including the memory system of FIG. 1; and

FIGS. 11 and 12 are diagrams illustrating a software layer structure of the computing system 300 of FIG. 10.

### DETAILED DESCRIPTION OF PREFERRED EMBODIMENTS

A memory device according to an embodiment of the present invention includes: word lines; and a plurality of memory cells connected to the word lines. In the memory device, the plurality of memory cells forms pages, and the number of sectors configuring each of the pages and the size of each of the sectors are changed. Hereinafter, preferred embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the invention to those skilled in the art. Like numerals refer to like elements throughout the specification.

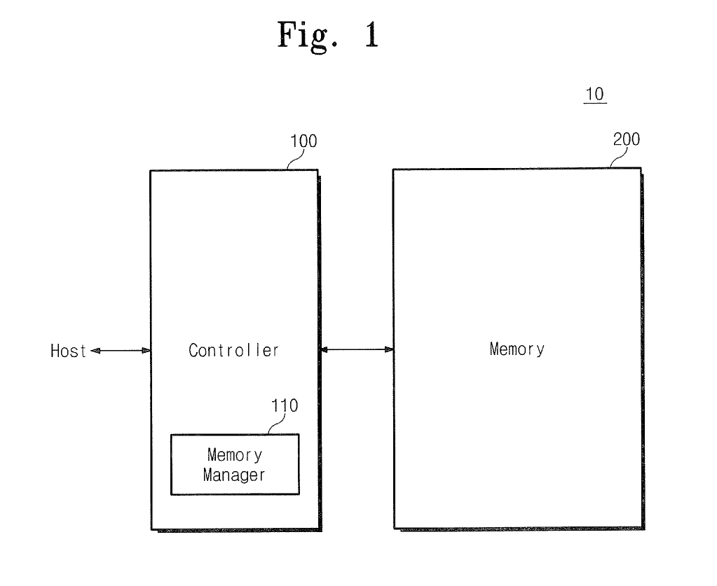

FIG. 1 is a block diagram of a memory system 10 according to an embodiment of the present invention. Referring to FIG. 1, the memory system 10 according to the embodiment of the present invention includes a memory device 200 and a controller 100.

The controller 100 is connected to a host and the memory device 200. The controller 100 sends data read from the memory device 200 to the host, and stores the data sent from the host in the memory device 200.

The controller 100 includes a memory manager 110. The memory manager 110 is software which can be driven in the controller 100. For example, if the memory 200 is a flash memory device, the memory manager 110 may include a flash translation layer. For example, the memory manager 110 receives a cluster size from the host and groups sectors of the memory device 200 so as to form clusters.

The controller 100 may further include well-known components such as a RAM, a processing unit, a host interface, and a memory interface. The RAM may be used as an operating memory of the processing unit. The processing unit may control the general operation of the controller 100. The host interface may include a protocol for exchanging data between the host and the controller 110. For example, the controller 100 may be configured to communicate with an external device (host) via one of various interface protocols such as a Universal Serial Bus (USB), a Multimedia Card (MMC), a Peripheral Component Interconnect-Express (PCI-E), an Advanced Technology Attachment (ATA), a Serial-ATA, a Parallel-ATA, a Small Computer System Interface (SCSI), an Enhanced Small Device Interface (ESDI), and an Integrated Drive Electronics (IDE). The memory interface may be interfaced with the memory device 200. The controller 100 may further include an error correction block. The error correction block may detect and correct an error of data read from the memory device 200.

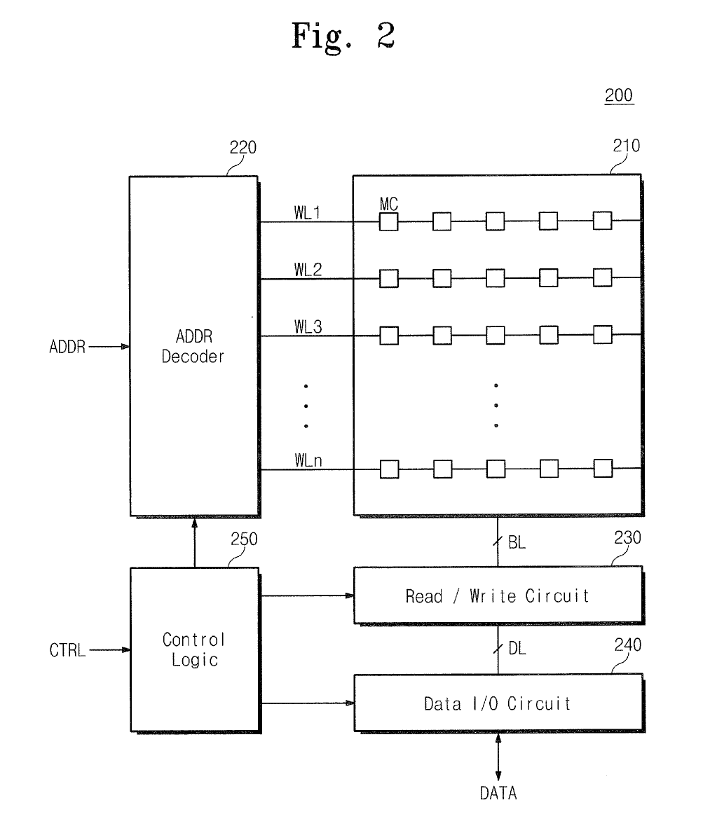

The memory device 200 may include a memory cell array for storing data, a read/write circuit for reading and writing data in the memory cell array, an address decoder for decoding an address sent from an external device and sending the address to the read/write circuit, a control logic for controlling the general operation of the memory device 200. The memory device 200 will be described in more detail with reference to FIG. 2.

The controller 100 and the memory device 200 may be integrated as one semiconductor device. For example, the controller 100 and the memory device 200 are integrated as one semiconductor device to configure a memory card. For example, the controller 100 and the memory device 200 may be integrated as one semiconductor device to configure a Personal Computer (PC) card (PCMCIA), a Compact Flash (CF) card, a Smart Media card (SM/SMC), a memory stick, a multimedia card (MMC, RS-MMC, or MMCmicro), a Secure Digital (SD) card (SD, miniSD, or microSD), or a Universal Flash Storage (UFS).

As another example, the controller 100 and the memory device 200 are integrated as one semiconductor device to configure a Solid State Disk/Drive (SSD). If the memory system 10 is used as the semiconductor disk (SSD), the operation rate of the host connected to the memory system 10 may be remarkably improved.

As another example, the memory system 10 is applicable to a personal digital assistant (PDA), a portable computer, a web tablet, a wireless phone, a mobile phone, a digital music player, or a device for transmitting/receiving information in a wireless environment.

As another example, the memory device 200 or the memory system 10 may be mounted in various package forms. For example, the memory device 200 or the memory system 10 may be packaged and mounted in one of various manners such as Package on Package (PoP), Ball Grid Arrays (BGAs), Chip Scale Packages (CSPs), Plastic Leaded Chip Carrier (PLCC), Plastic Dual In-Line Package (PDIP), Die in Waffle Pack, Die in Wafer Form, Chip On Board (COB), Ceramic Dual In-Line Package (CERDIP), Plastic Metric Quad Flat Pack (MQFP), Thin Quad Flatpack (TQFP), Small Outline (SOIC), Shrink Small Outline Package (SSOP), Thin Small Outline (TSOP), Thin Quad Flatpack (TQFP), System In Package (SIP), Multi Chip Package (MCP), Wafer-level Fabricated Package (WFP), or Wafer-Level Processed Stack Package (WSP).

FIG. 2 is a block diagram of the memory device 200 of FIG. 1. Referring to FIG. 2, the memory device 200 according to the embodiment of the present invention includes a memory cell array 210, an address decoder 220, a read/write circuit 230, a data input/output circuit 240, and a control logic 250.

The memory cell array 210 is connected to the address decoder 220 through word lines WL1 to WLn and is connected to the read/write circuit 230 through bit lines BL. The memory cell array 210 includes a plurality of memory cells (MC) connected to the word lines WL1 to WLn. The memory cells MC are connected to the bit lines BL corresponding thereto. For example, the bit lines BL may be formed in a direction crossing the word lines WL1 to WLn, and the memory cells MC may be arranged at regions in which the word lines WL1 to WLn and the bit lines BL cross each other. For brevity of description, the bit lines BL in the memory cell array 210 are not shown.

Each of the memory cells MC store data. For example, each of the memory cells MC may store data by changing the threshold voltage of a memory cell transistor using hot electrons injected into a charge storage layer by hot electron injection. As another example, each of the memory cells MC may store data by changing the threshold voltage of a memory cell transistor using charges stored/captured in a charge storage layer by Fowler-Nordheim (F-N) tunneling.

As another example, each of the memory cells MC may include a phase change material and store data by applying a predetermined temperature to the phase change material during a predetermined time so as to change the resistance of the phase change material. As another example, each of the memory cells MC may include a magnetic material having a parallel or anti-parallel magnetization direction, and store data by changing the resistance of the magnetic material via changing of the magnetization direction of the magnetic material.

As another example, each of the memory cells MC may include a ferroelectric material and store data by adjusting the polarization of the ferroelectric material. As another example, each of the memory cells MC may store data by charging charges in a capacitor. As another example, each of the memory cells MC may be a latch including one or more transistors.

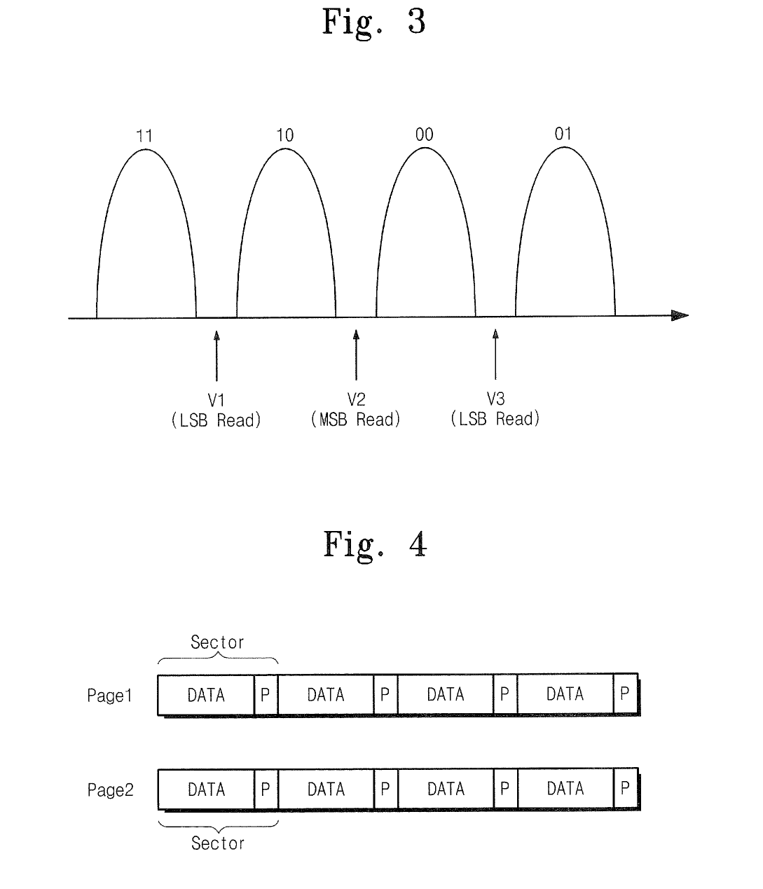

Each of the memory cells MC may store at least one data bit. If each of the memory cells MC stores one data bit, the memory cells MC connected to one word line (e.g., WL2) may form one page. If each of the memory cells MC stores two or more data bits, the memory cells MC connected to one word line (e.g., WL2) may form two or more pages. The pages formed in the memory cell array 210 will be described in detail with reference to FIG. 3.

The address decoder 220 is connected to the memory cell array 210 and the control logic 250. The address decoder 220 operates in response to the control of the control logic 250. The address decoder 220 receives and decodes an address ADDR from an external device and decodes the received address ADDR. For example, the address ADDR may be supplied from the controller 100 of FIG. 1. The address decoder 220 decodes a row address of the address ADDR received from the external device and selects the word lines WL1 to WLn. The address decoder 220 decodes a column address of the address ADDR received from the external device and sends the decoded address to the read/write circuit. For example, the address decoder 220 may include components which are well known in the art, such as a row address decoder, a column address decoder and an address buffer.

The read/write circuit 230 is connected to the memory cell array 230, the data input/output circuit 240, and the control logic 250. The read/write circuit 230 operates in response to the control of the control logic 250. The read/write circuit 250 selects the bit lines BL in response to the column address (not shown) received from the address decoder 220.

The read/write circuit 230 writes the data received from the data input/output circuit 240 through data lines DL in the memory cell array 210. The read/write circuit 230 reads data from the memory cell array 210 and sends the data to the data input/output circuit 240 through the data lines DL. As another example, the read/write circuit 230 may read data from a first storage region (e.g., a first page) of the memory cell array 210 and write the data in a second storage region (e.g., a second page) of the memory cell array 210.

For example, the read/write circuit 230 may include components which are well known in the art, such as a page buffer and a column selection gate. As another example, the read/write circuit 230 may include components which are well known in the art, such as a write driver, a sense amplifier, and a column selection gate.

The data input/output circuit 240 is connected to the read/write circuit 230 and the control logic 250. The data input/output circuit 240 operates in response to the control of the control logic 250. The data input/output circuit 240 exchanges data DATA with an external device. The data input/output circuit 240 sends the data DATA received from the external device to the read/write circuit 230 through the data lines DL. The data input/output circuit 240 sends data DATA received from the read/write circuit 230 through the data lines DL to the external device. For example, the data input/output circuit 240 may exchange data DATA with the controller 100 of FIG. 1. For example, the data input/output circuit 240 may include components which are well known in the art, such as a data buffer.

The control logic 250 is connected to the address decoder 220, the read/write circuit 230, and the data input/output circuit 240. The control logic 250 controls the general operation of the memory device 200. The control logic 250 operates in response to a control signal CTRL sent from the external circuit. For example, the control signal CTRL may be supplied from the controller 100 of FIG. 1.

FIG. 3 is a diagram illustrating a threshold voltage distribution of memory cells which stores two data bits per cell. In FIG. 3, a horizontal axis denotes a voltage V and a horizontal axis (not shown) denotes the number of memory cells.

If two data bits are stored in one memory cell, the memory cell is programmed so as to have one state of “11”, “10”, “00”, and “01” as shown in FIG. 3. A first data bit of the two data bits stored in the memory cell is a Most Significant Bit (MSB). That is, if the memory cell stores “11” or “10”, the MSB stored in the memory cell is “1”. In contrast, if the memory cell stores “00” or “01”, the MSB stored in the memory cell is “0”. That is, if the read operation is performed using a voltage V2, the MSB stored in the memory cell is read.

A second bit of the two data bits stored in the memory cell is a bit lower than the MSB. Since it is assumed that the memory cell stores the two data bits, the second bit of the two data bits stored in the memory cell is a Least Significant Bit (LSB). That is, if the memory cell stores “11” or “01”, the LSB stored in the memory cell is “1”. In contrast, if the memory cell stores “10” or “00”, the LSB stored in the memory cell is “0”.

The number of read operations for distinguishing the LSB stored in the memory cell is twice the number of read operations for distinguishing the MSB. For example, the read operation is performed using the voltage V2, and, if the MSB is “1”, the read operation is performed using a voltage V1 such that the LSB is distinguished. In addition, the read operation is performed using the voltage V2, and, if the MSB is “0”, the read operation is performed using a voltage V3 such that the LSB is distinguished.

The phenomenon in which the number of read operations for distinguishing a low-order bit is more than the number of read operations for distinguishing a high-order bit is applicable to a memory device for storing data of n numbers per memory cell. In the memory device for storing data of n numbers per memory cell, if it is assumed that states are mapped using gray coding, the number of read operations for distinguishing a k-th bit may be twice the number of read operations for distinguishing a (k−1)-th bit.

For example, the MSB of the data bits stored in the memory cell is distinguished by performing the read operation once. A first low-order bit which is lower than the MSB by one may be distinguished by performing the read operation twice as large as the number of read operations for distinguishing the MSB. A second low-order bit which is lower than the first low-order bit by one is distinguished by performing the read operation four times. Similarly, in the memory device in which k data bits are stored in one memory cell, the LSB is distinguished by performing the read operation 2̂(k−1) times.

When the read operation is performed, a read error may occur due to an abnormal distribution of the threshold voltages of the memory cells or instability of a read voltage. That is, as the number of read operations for distinguishing the data bits stored in the memory cell increases, the probability of the read-error occurrence increases. For example, it is assumed that the probability of the read-error occurrence is p when the read operation is performed once. At this time, when the read operation is performed once in order to distinguish the MSB data, the probability of the read-error occurrence may be p. In contrast, when the read operation is performed four times in order to distinguish a third low-order bit, the probability of the read-error occurrence may be increased to 4p. That is, it will be understood that the probability of the read-error occurrence during distinguishing the low-order bit data is higher than the probability of the read-error occurrence during distinguishing the high-order bit data.

Referring to FIGS. 2 and 3, the memory cells MC connected to one word line (e.g., WL2) forms pages corresponding to the number of data bits stored in each of the memory cells. For example, when each of the memory cells MC store high-order and low-order bit data, the high-order bit data stored in each of the memory cells MC forms one page, and the low-order bit data stored in each of the memory cells MC forms another page.

Hereinafter, the data bits stored in each of the memory cells MC and the pages corresponding thereto will be described as the same layer. That is, the MSB stored in each of the memory cells MC connected to the word line (e.g., WL2) forms a highest-order page, the first low-order bit data stored in each of the memory cells MC connected to the word line WL2 forms a first low-order page, and the LSB stored in each of the memory cells connected to the word line WL2 forms a lowest-order page.

In order words, if n data bits are stored in each of the memory cells, the memory cells MC connected to each of the word lines form n pages, and each of the pages stores data corresponding thereto. At this time, the number of data bits stored in each of the pages may be equal to the number of memory cells MC connected to the word line (e.g., WL2). In addition, the probability of the read-error occurrence in a low-order page may be higher than that in a high-order page.

As described with reference to FIG. 3, each memory cell MC stores two data bits. That is, the memory cells MC connected to one word line WL configure two pages, for example, a highest-order page and a lowest-order page. In the logic states “11” and “10”, the logic value of the highest-order page is “1”. In the logic states “00” and “01”, the logic value of the highest-order page is “0”. That is, as the threshold voltage of the memory cell MC increases, the logic value of the highest-order page is changed from “1” to “0”.

In the logic state “11”, the logic value of the lowest-order page is “1”. In the logic states “10” and “00”, the logic value of the lowest-order page is “0”. In the logic state “01”, the logic value of the lowest-order page is “1”. That is, as the threshold voltage of the memory cell MC increases, the logic value of the lowest-order page is changed “1” to “0” and is then changed from “0” to “1”.

As the threshold voltage the memory cell MC increases, the logic value of the highest-order page is changed once. As the threshold voltage of the memory cell MC increases, the logic value of the lowest-order page is changed twice. Similarly, the number of changes in the logic value of each page according to the change in the threshold voltage of the memory cell MC is larger than between the highest-order page and the n-th low-order page compared to between the highest-order page and the (n−1)-th low-order page.

In addition, as described above, the probability of the error occurrence in the low-order page is higher than that of the error occurrence in the high-order page. That is, when comparing a page in which the number of changes in the logic value according to the change in the threshold voltage of the memory cell MC is relatively large to a page in which the number of changes in the logic value according to the change in the threshold voltage of the memory cell MC is relatively small, the probability of the error occurrence in the relatively large page is higher than that of the error occurrence in the relatively small page. That is, it will be understood that the reliability of each page is determined by the number of changes in the logic value according to the change in the threshold voltage of the memory cell MC of each page.

In the above-described embodiment, the teens “MSB/high-order/low-order/LSB data bit” and “highest-order/high-order/low-order/lowest-order page” are used. However, it will be understood that the technical spirit of the present invention is not limited to the terms “MSB/high-order/low-order/LSB data bit” and “highest-order/high-order/low-order/lowest-order page”. In the memory device where at least two data bits are stored in one memory cell, it will be understood that the directivity from the high-order to the low-order or from the low-order to the high-order may be changed according to the programming/reading manner. For example, the read operation is performed k times in order to distinguish the first data bit, and the read operation is performed h times in order to distinguish the second data bit. If k is larger than h, the second data bit is the high-order data bit compared to the first data bit.

In the above-described embodiment, the probability of the read-error occurrence in the high-order data bit is lower than that of the read-error occurrence in the low-order bit, and the probability of the read-error occurrence in the high-order page is lower than that of the read-error occurrence in the low-order page. However, the present invention is not limited to the fact that the probability of the read-error occurrence changes depending on the order of the high-order and the low-order. It will be understood that the probability of program-error occurrence in the low-order data bit is higher than that of the program-error occurrence in the high-order data bit, and the probability of the program-error occurrence in the low-order page is higher than that of the program-error occurrence in the high-order page. That is, it will be understood that the reliability of the low-order data bit is lower than that of the high-order data bit and the reliability of the low-order page is lower than that of the high-order page.

In the above-described embodiment, the states are mapped using the gray coding. However, in the memory device for storing n-bit data per memory cell, when the states are mapped using a coding manner other than the gray coding, it will be understood that the reliability of the high-order page and the low-order page may be changed.

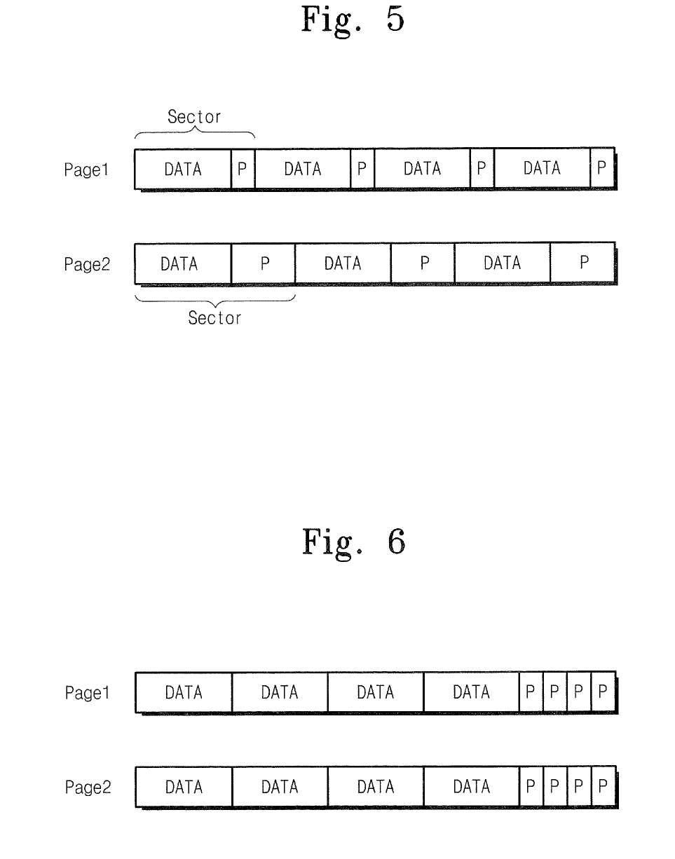

FIGS. 4 to 7 are diagrams illustrating a method of storing sectors according to a first embodiment of the present invention. In FIGS. 4 to 7, it is assumed that the memory cells connected to one word line forms two pages, that is, a highest-order page and a lowest-order page. In order words, it is assumed that each of the memory cells stores two data bits, that is, an MSB and an LSB.

Referring to FIG. 4, two pages Page1 and Page2 are formed in the memory cells connected to one word line. For convenience of description, it is assumed that the page “Page1” is the highest-order page and the page “Page2” is the lowest-order page. In addition, it is assumed that four sectors are stored in one page and each of the sectors includes data “DATA” and parity P. For example, the parity P may be generated using one of various codes such as a Hamming code, a Bose Chaudhuri Hocquenghem (BCH) code, and a Reed-Solomon code.

As described with reference to FIG. 3, the reliability of the highest-order page “Page1” is different from the reliability of the lowest-order page “Page2”. That is, the reliability of the lowest-order page “Page2” is lower than that of the highest-order page “Page1”. If the sizes of the sectors stored in the highest-order page “Page1” is equal to those of the sectors in the lowest-order page “Page2”, that is, if the same number and size of data “DATA” and parity P are stored in the highest-order page “Page1” and the lowest-order page “Page2”, the same error correction function may be provided to the data “DATA” stored in the highest-order page “Page1” and the lowest-order page “Page2”. For example, if k-bit error can be corrected in the data “DATA” and the parity P of a sector by using the parity P of one sector of the highest-order page “Page1”, the k-bit error can be corrected in the data “DATA” and the parity P of a sector using the parity P of one sector of the lowest-order page “Page2”.

At this time, the error out of the error correction range using the parity P may occur in each page. The probability of this error occurrence may be changed depending on whether the error correction function is provided to either the highest-order “Page1” or the lowest-order page “Page2”. Hereinafter, the error correction capability will be described based on the size of the parity P. If the parity P is formed by using the same code with respect to the data “DATA” having the same size, as the number of parity bits increases, the error correction capability is improved. Accordingly, the error correction capability may be appreciated by the size of the parity P.

For example, the size of the parity P may be determined based on the probability of the error occurrence in the highest-order page “Page1”. That is, the size of the parity P is determined such that the probability of the error occurrence out of the error correction range in the highest-order page “Page1” is within a tolerable range of the system. The probability of the error occurrence in the lowest-order page “Page2” is higher than that of the error occurrence in the highest-order page “Page1”.

That is, if the size of the parity P is determined based on the probability of the error occurrence in the highest-order page “Page1”, although the probability that the error out of the error correction range occurs in the highest-order page “Page1” is within the tolerable range of the system, the probability that the error out of the error correction range occurs in the lowest-order page “Page2” is out of the tolerable range of the system. Accordingly, if the size of the parity P is determined based on the probability of the error occurrence in the highest-order page “Page1”, the reliability of the lowest-order page “Page2” may be out of the tolerable range of the system.

As another example, the size of the parity P may be determined based on the probability of the error occurrence in the lowest-order page “Page2”. That is, the size of the parity P may be determined such that the probability of the error occurrence out of the error correction range in the lowest-order page “Page2” is within the tolerable range of the system. The probability of the error occurrence in the lowest-order page “Page2” is higher than that of the error occurrence in the highest-order page “Page1”. That is, the probability that the error out of the error correction range occurs in the highest-order “Page1” and the lowest-order page “Page2” may be within the tolerable range of the system. However, the size of the parity P determined based on the lowest-order page “Page2” is larger than that of the parity P determined based on the highest-order page “Page1”. That is, since more memory cells are allocated for storing the parity P, the data storage efficiency of the memory device can be reduced.

In order to solve the above-described problems, the memory device 200 (see FIGS. 1 and 2) according to the embodiment of the present invention includes the word lines and the plurality of memory cells connected to the word lines, wherein the plurality of memory cells forms the pages, and the number of sectors configuring the pages and the size of each of the sectors are changed. Hereinafter, the technical spirit of the present invention will be described in detail with reference to the drawings.

Referring to FIG. 5, four sectors are stored in the highest-order page “Page1”, and three sectors are stored in the lowest-order page “Page2”. That is, in the memory device according to the embodiment of the present invention, the number of sectors configuring the page and the size of each of the sectors can be changed, and the number of sectors configuring the high-order page and the low-order page and the size of each of the sectors can independently be changed in each of the pages. In addition, the number of sectors stored in the page having low reliability (e.g., the lowest-order page “Page2”) is more reduced compared to the number of sectors stored in the page having high reliability (e.g., the highest-order page “Page1”). The parity P is stored in a storage capacity corresponding to the reduced number of sectors. That is, the size of the parity P in the sectors configuring the page is increased as much as the number of sectors configuring the page is reduced.

In summary, in the memory device according to the embodiment of the present invention, the size of the parity can be changed according to the reliability of the page. Accordingly, the probability that the error out of the error correction range occurs in each page is reduced to the tolerable range of the system. In addition, each of the pages can be provided with the parity having a minimum size in which the error within the tolerable range of the system occurs. Accordingly, the data storage efficiency can be improved.

FIGS. 6 and 7 are diagrams showing embodiments in which the data “DATA” and the parity P are stored in separate storage regions in the pages “Page1 and Page2”. Each page is divided into a data storage region and a parity storage region. The data “DATA” is stored in the data storage region, and the parity P is stored in the parity storage region. As illustrated in FIGS. 6 and 7, even when the data “DATA” and the parity P are stored in the separate storage regions, it will be understood that the size of the sector can be changed according to the reliability of the page.

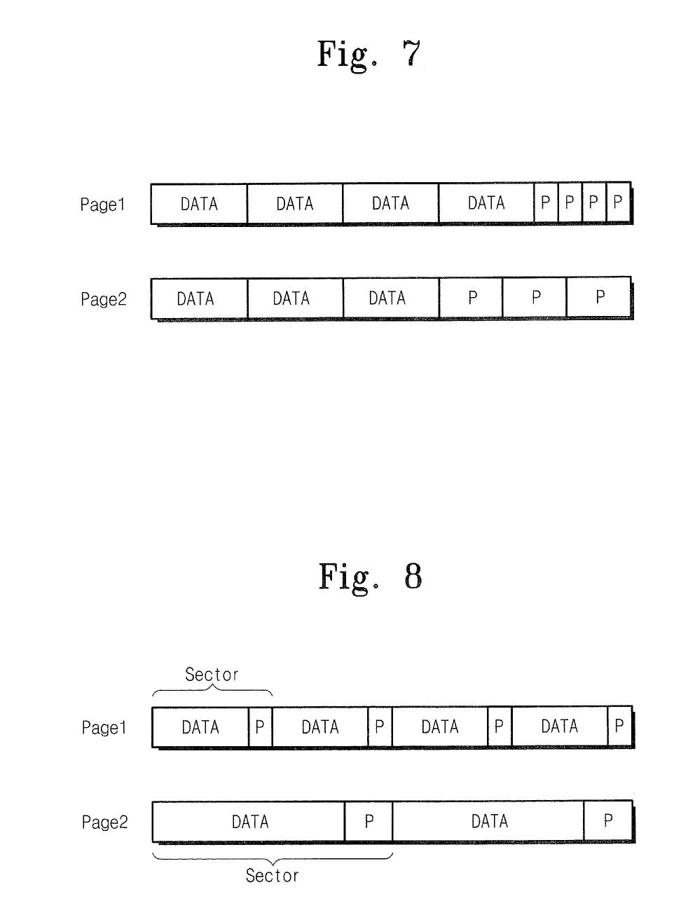

FIG. 8 is a diagram illustrating a method of storing sectors according to a second embodiment of the present invention. Referring to FIG. 8, four sectors are stored in the highest-order page “Page1”, and two sectors are stored in the lowest-order page “Page2”. That is, the sectors stored in the page “Page2” are regrouped into one or more groups, and each of the regrouped groups may be set to a new sector. Accordingly, the capacity of the sectors stored in the lowest-order page “Page2” may be an integral multiple of that of the sectors stored in the highest-order page “Page1”. As illustrated in FIG. 8, when four sectors are stored in the highest-order page “Page1” and two sectors are stored in the lowest-order page “Page2”, the capacity of the sectors stored in the lowest-order page “Page2” may be twice that of the sectors stored in the highest-order page “Page1”.

The highest-order page “Page1” and the lowest-order page “Page2” may provide the same data storage capacity. That is, the storage capacities for the data “DATA” of each page are equal to one another, and the storage capacities for the parity P of each page are equal to one another. The storage capacity of each sector in the highest-order page “Page1” is obtained by dividing the storage capacity of the highest-order page “Page1” into four parts, and the storage capacity of each sector in the lowest-order page “Page2” is obtained by dividing the storage capacity of the lowest-order page “Page2” into two parts.

That is, the ratio of the data “DATA” and the parity P of each sector in the highest-order page “Page1” is equal to that of the data “DATA” and the parity P of each sector in the lowest-order page “Page2”. In other words, the coding rate (the ratio of the data “DATA” and the parity P) of the data “DATA” and the parity P of the sectors in the highest-order page “Page1” is equal to that of the data “DATA” and the parity P of the sectors in the lowest-order page “Page2”.

When the coding rates of a first sector is equal to a second sector, and when the capacity of the first sector is larger than that of the second sector, the probability of the error occurrence out of the error correction range in the first sector is lower than that of the error occurrence out of the error correction range in the second sector. For example, it is assumed that the data capacity of the second sector is 512 bytes and the data capacity of the first sector is 4096 bytes. Since the coding rates of the first and second sectors are equal to each other, if the error correction range of the second sector is h-bit, the error correction range of the first sector is a value close to 8h. In more detail, when the error correction range of the first sector is h-bit, the error correction range of the second sector is a value close to 8h and can be changed according to a kind of the error correction code. For brevity, it is assumed that the error correction range of the first sector is h-bit and the error correction range of the second sector is 8h.

The capacity of one first sector corresponds to the capacity of eight second sectors. In one first sector, 8h error bits of the 4096-byte data may be corrected. In the eight second sectors, 8h error bits of the 4096-byte data may be corrected. However, even when 2h error bits (within the error correction range in view of the eight second sectors) occurs in the eight second sectors, if the 2h error bits are generated in one of the eight second sectors, the errors cannot be corrected. In contrast, in any case, 8h or less error bits may be corrected in the first sector. That is, if the coding rates of the first and second sectors are equal to each other and the capacity of the first sector is larger than that of the second capacity, the error correction range of the first sector is larger than that of the second sector.

Referring to FIG. 8, the sectors stored in the lower-order page “Page2” are regrouped into one or more groups, and each of the regrouped groups is set to a new sector. That is, the capacity of the sectors stored in the lowest-order page “Page2” is larger than that of the sectors stored in the highest-order page “Page1”, and the coding rate of the highest-order “Page1” is equal to that of the lowest-order page “Page2”. Accordingly, the error correction range of the lowest-order page “Page2” is larger than that of the highest-order page “Page1”. That is, the memory device according to the embodiment of the present invention independently adjusts the error correction function of each page according to the reliability of the pages “Page1 and Page2”. For example, the error correction function provided to the page having low reliability may be large in the error correction range compared to the error correction function provided to the page having high reliability.

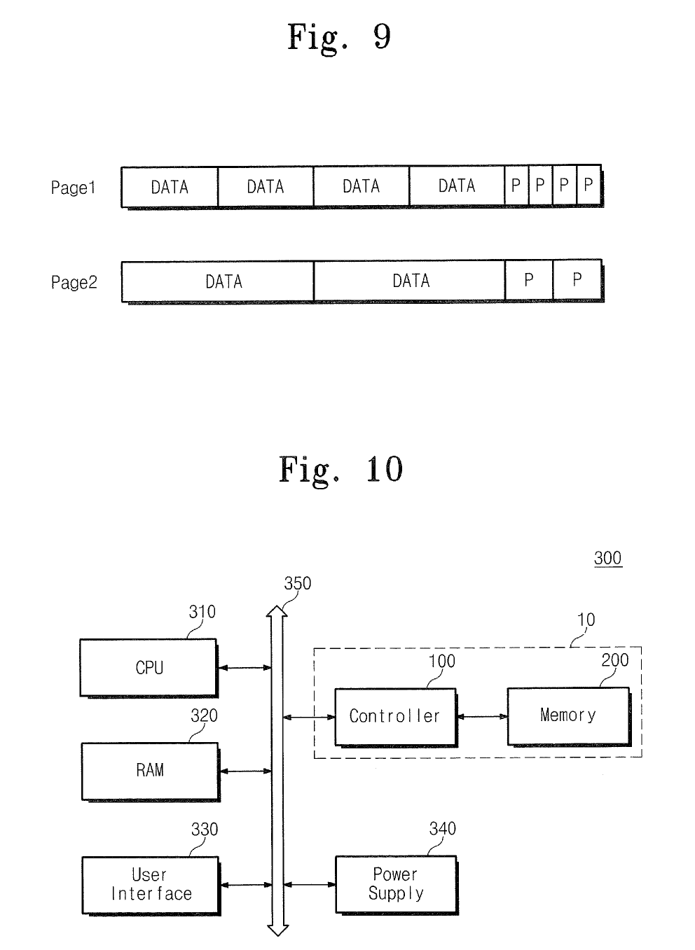

FIG. 9 is a diagram illustrating a case where data and parity are independently stored in separate storage regions. As illustrated in FIG. 9, even when each page is divided into a data storage region for storing the data “DATA” and a parity storage region for storing the parity P, the number of sectors configuring each page and the size of each sector can be independently changed in each page according to the technical spirit of the present invention.

As described above, the memory device according to the embodiment of the present invention includes the word lines and the plurality of memory cells connected to the word lines. In this memory device, the plurality of memory cells forms the pages, and the number of sectors configuring the pages and the size of each of the sectors can be changed. Accordingly, the reliability and the data storage efficiency of the memory device are improved.

According to the above-described embodiment, the memory cells connected to one word line form two pages. However, the number of pages according to the technical spirit of the present invention is not limited. If each of the memory cells stores 3-bit data, the memory cells connected to one word line form three pages. If each of the memory cells stores n-bit data, the memory cells connected to one word line form n pages. The memory device according to the embodiment of the present invention can independently change the size of each of the sectors stored in the n pages.

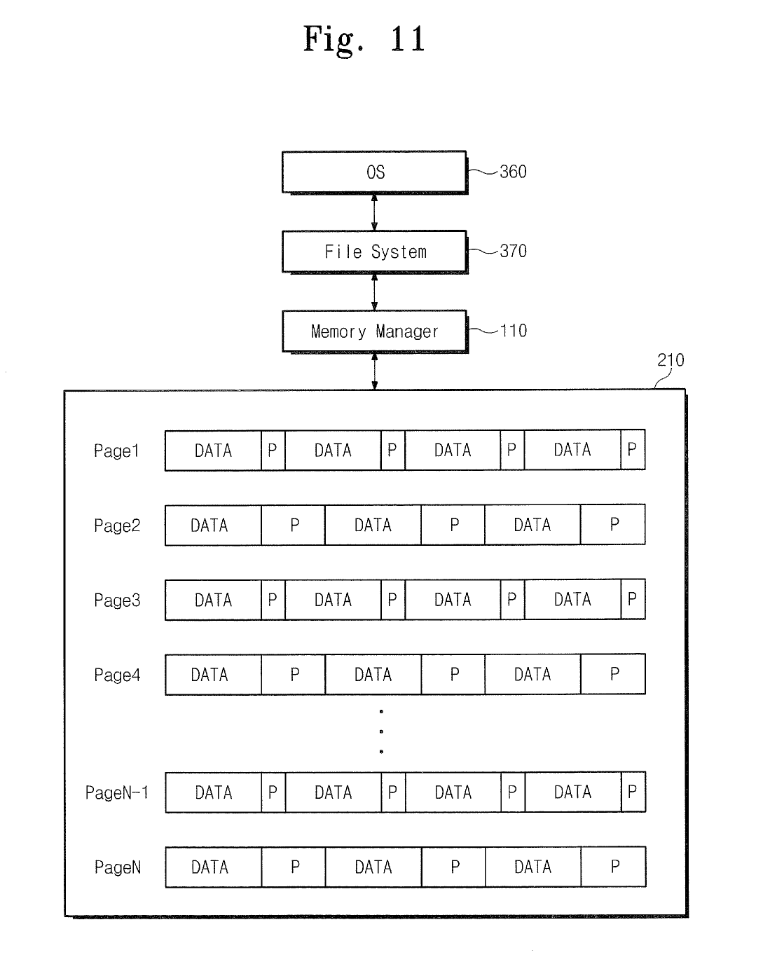

FIG. 10 is a block diagram illustrating an embodiment of a computing system 300 including the memory system 10 of FIG. 1. Referring to FIG. 10, the computing system 300 according to the embodiment of the present invention includes a central processing unit (CPU) 310, a RAM 320, a user interface 330, a power supply 340 and the memory system 10.

The memory system 10 is electrically connected to the CPU 310, the RAM 320, the user interface 330 and the power supply 340 through a system bus 350. Data supplied through the user interface 330 or processed by the CPU 310 is stored in the memory system 10. The memory system 10 includes a controller 100 and a flash memory device 200.

If the memory system 10 is mounted in a SSD, the booting speed of the computing system 300 can be remarkably increased. Although not illustrated in the drawing, it will be apparent to those skilled in the art that the system according to the present invention further includes an application chipset, a camera image processor, and so on.

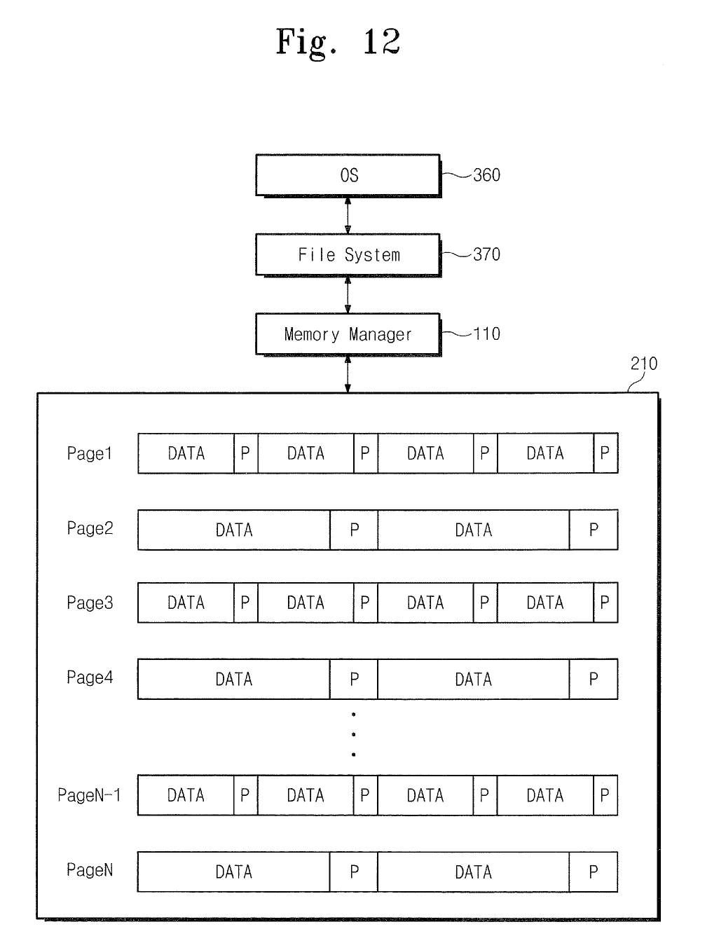

FIGS. 11 and 12 are diagrams illustrating a software layer structure of the computing system 300 of FIG. 10. Referring to FIGS. 10 to 12, the software layer structure of the computing system 300 includes an Operating System (OS) 360, a file system 370, a memory manager 110, and a storage region 210.

The operating system 360 and the file system 370 may be operated by the CPU 310. The memory manager 110 may be provided by the controller 100 of the memory system 10 or the memory device 200. The storage region 210 may be provided by the memory device 200 of the memory system 10.

The operating system 360 and the file system 370 may process data by a cluster unit. The memory system 10 may process data by a sector unit. The memory system 10 receives the size of a cluster from the operating system 360 and the file system 370, groups a plurality of sectors, and forms the cluster.

FIG. 11 is a diagram illustrating the case where the number of sectors configuring the page and the size of each sector can be changed by the method described with reference to FIGS. 4 to 7 in the storage region 210. Referring to FIG. 11, the pages “Page1, Page3, and PageN−1” are the highest-order pages, and the pages “Page2, Page4, and Page N” are the lowest-order pages. The number of sectors stored in the lowest-order pages “Page2, Page4, and Page N” are smaller than the number of sectors stored in the highest-order pages “Page1, Page3, and PageN−1”. The size of the parity P of each sector stored in the lowest-order pages “Page2, Page4, and Page N” is larger than that of the parity P of each sector stored in the highest-order pages “Page1, Page3, and PageN−1”. That is, the error correction range of the lowest-order pages “Page2, Page4, and Page N” is larger than that of the highest-order pages “Page1, Page3, and PageN−1”.

The data capacity of the sectors stored in the highest-order pages “Page1, Page3, and PageN−1” is equal to that of the sectors stored in the lowest-order pages “Page2, Page4, and Page N”. For example, it is assumed that the data capacity of the sector is 512 bytes and the size of the cluster is 4096 bytes. The memory manager 110 groups eight sectors to form the cluster. For example, one cluster is formed by seven sectors of the pages “Page1 and Page2” and one sector of the page “Page3”.

If the programming and erasing of the memory device are repeated, the memory cells of the memory device deteriorate and thus the reliability of the memory cells is declined. That is, the reliability of the pages “Page1 to Page N” is declined. In the memory device according to the embodiment of the present invention, the number of sectors configuring the pages and the size of each sector can be changed depending on the reliability of the pages “Page 1 to Page N”. For example, if the reliability of the pages “Page1 to Page N” is declined by the repetitive programming and erasing processes, the number of sectors stored in the pages “Page 1 to Page N” is reduced. For example, three sectors are stored in each of the highest-order pages “Page1, Page3, and PageN−1”, and two sectors are stored in each of the lowest-order pages “Page2, Page4, and Page N”. The parities of the sectors may be stored in the storage regions corresponding to the reduced number of sectors. Accordingly, the error correction range of the sectors stored in the pages “Page1 to Page N” may be enlarged.

The memory manager 110 groups the plurality of sectors to form a cluster. For example, if the data size of the sector is 512 bytes and the size of the cluster is 4096 bytes, the memory manager 110 forms the cluster by grouping eight sectors.

FIG. 12 is a diagram illustrating the case where the number of sectors configuring the page and the size of each sector are changed by the method described with reference to FIGS. 8 and 9 in the storage region 210. Referring to FIG. 12, the pages “Page1, Page3, and PageN−1” are the highest-order pages and the pages “Page2, Page4, and Page N” are the lowest-order pages. The number of sectors stored in the lowest-order pages “Page2, Page4, and Page N” is smaller than that of pages stored in the highest-order pages “Page1, Page3, and PageN−1”. The capacity of the sectors stored in the lowest-order pages “Page2,Page4, and Page N” is the integral multiple (e.g., twice) of that of sectors stored in the highest-order pages “Page1, Page3, and PageN−1”. The coding rate of the data “DATA” and the parity P of the sectors stored in the lowest-order pages “Page2, Page4, and Page N” is equal to that of the data “DATA” and the parity P of the sectors stored in the highest-order pages “Page1, Page3, and Page N”. That is, the error correction range of the lowest-order pages “Page2, Page4, and Page N” may be larger than that of the highest-order pages “Page1, Page3, and PageN−1”.

For example, it is assumed that the data capacity of the sectors stored in the highest-order pages “Page1, Page3, and PageN−1” is 512 bytes, the data capacity of the sectors stored in the lowest-order pages “Page2, Page4, and Page N” is 1024 bytes, and the size of the cluster is 4096 bytes. The memory manager 110 may form the cluster by grouping the plurality of sectors. For example, one cluster may be formed by four sectors of the page “Page1” and two sectors of the page “Page2”. That is, the cluster may be formed by the sectors of the highest-order pages “Page1, Page3, and PageN−1” and the lowest-order pages “Page2, Page4, and Page N”.

As another example, one cluster may be formed by eight sectors of the pages “Page1 and Page3”, and another cluster may be formed by four sectors of the pages “Page2 and Page4”. That is, one cluster is formed by the sectors stored in the highest-order pages “Page1, Page3, and PageN−1”, and another cluster is formed by the sectors stored in the lowest-order pages “Page2, page4, and Page N”.

If the programming and erasing of the memory device are repeated, the memory cells of the memory device deteriorate, and the reliability of the memory cells may be declined. That is, the reliability of the pages “Page1 to Page N” may be declined. In the memory device according to the embodiment of the present invention, the number of sectors configuring the page and the size of each sector can be changed according to the reliability of the pages “Page1 to Page N”. For example, if the reliability of the pages “Page1 to Page N” is declined by the repetitive programming and erasing processes, the number of sectors stored in the pages “Page1 to Page N” may be reduced. The sectors stored in each of pages are regrouped into one or more groups, and each of the groups is set to a new sector.

For example, four sectors stored in each of the highest-order pages “page1, Page3, and PageN−1” are divided into two groups, and each of the groups may be set to the new sector. That is, the data capacity of the sectors stored in each of the highest-order pages “Page1, Page3, and PageN−1” is doubled. For example, if each of the highest-order pages “Page1, Page3, and PageN−1” is formed of four sectors each having 512 bytes, the four sectors each having 512 bytes may be divided into two groups. That is, each of the groups may include two sectors each having 512 bytes. Each of the groups may be set to the new sector. That is, each of the highest-order pages “page1, Page3, and PageN−1” may be set to store two sectors each having 1024 bytes.

For example, two sectors stored in each of the lowest-order pages “Page2, Page4, and Page N” may be set to one new sector. That is, the data capacity of the sectors stored in each of the lowest-order pages “Page2, Page4, and Page N” may be doubled. For example, if each of the lowest-order pages “Page2, Page4, and Page N” is formed of two sectors each having 1024 bytes, each of the lowest-order pages “Page2, page4, and Page N” may be set to store one new sector having 2048 bytes.

Since the capacity of each sector in the highest-order and lowest-order pages “Page1 to Page N” is increased, the error correction rang of each sector in the highest-order and lowest-order pages “Page1 to Page N” may be enlarged.

The memory manager 110 may form a cluster by grouping a plurality of sectors. For example, it is assumed that the data capacity of the sectors stored in each of the highest-order pages “Page1, Page3, and PageN−1” is 1024 bytes, the data capacity of the sectors stored in each of the lowest-order pages “Page2, Page4, and Page N” is 4096 bytes, and the size of the cluster is 4096 bytes. The memory manager 110 may form the cluster by grouping the plurality of sectors. For example, one cluster may be formed by two sectors of the page “Page1” and one sector of the page “Page2”. That is, the cluster may be formed by the sectors stored in the highest-order pages “Page1, Page3, and PageN−1” and the lowest-order pages “page2, Page4, and Page N”.

As another example, one cluster may be formed by four sectors of the pages “Page1 and Page3”, and another cluster may be formed by two sectors of the pages “Page2 and Page4”. That is, one cluster may be formed by the sectors stored in the highest-order pages “Page1, Page3, and PageN-1”, and another cluster may be formed by the sectors stored in the lowest-order pages “Page2, Page4, and Page N”.

Although the number and the capacity of the sectors stored in the pages “Page1 to Page N” are described using the specific values, the number of sectors stored in the pages “Page1 to Page N” of the memory device according to the embodiment of the present invention is not limited thereto.

According to the embodiment of the present invention, the memory device includes word lines, and a plurality of memory cells connected to the word lines. The plurality of memory cells forms the pages, and the number of sectors configuring the pages and the size of each sector can be changed. Accordingly, it is possible to improve reliability and data storage efficiency of the memory device.

Although the present invention has been described in connection with the embodiment of the present invention illustrated in the accompanying drawings, it is not limited thereto. It will be apparent to those skilled in the art that various substitution, modifications and changes may be thereto without departing from the scope and spirit of the invention.

What is claimed is:

1. A memory device comprising:
a word line; and
a plurality of memory cells connected to the word line,
wherein the plurality of memory cells forms a page, and
wherein the number of sectors configuring the page and the size of each of the sectors are changed.

2. The memory device as set forth in claim 1, wherein the number of sectors configuring the pages is reduced, when the reliability of the page is low.

3. The memory device as set forth in claim 2, wherein the reliability of the page is determined by a program/erase cycle number of the page.

4. The memory device as set forth in claim 2, wherein the reliability of the page is determined by a change number in a logic value of the page according to a change in threshold voltages of the memory cells of the page.

5. The memory device as set forth in claim 2, wherein the reliability of the page is determined by the number of times a read voltage is applied to the page in order to determine a logic state of each of the memory cells of the page.

6. The memory device as set forth in claim 2, wherein parities for the sectors stored in the page are stored in a storage capacity corresponding to the reduced number of sectors.

7. The memory device as set forth in claim 2, wherein the sectors stored in the page regroups into one or more groups, and the groups are set to new sectors.

8. The memory device as set forth in claim 7, wherein the groups have the same storage capacity one another.

9. The memory device as set forth in claim 7, wherein a coding rate of the sectors stored in the memory cells is equal to that of the new sectors.

10. The memory device as set forth in claim 1, wherein:
the memory cells store high-order data bits and low-order data bits, respectively;
the high-order data bits of the memory cells form a high-order page, and the low-order data bits of the memory cells form a low-order page; and
the number of sectors configuring the high-order and low-order pages and the size of each of the sectors are independently changed in each of the pages.

11. The memory device as set forth in claim 10, wherein the number of sectors configuring the low-order page is set to be smaller than the number of sectors configuring the high-order page, when the number of read operations required for distinguishing the high-order data bits is smaller than the number of read operations required for distinguishing the low-order data bits.

12. A memory system comprising:
a memory device; and
a controller controlling the memory device,
wherein: the memory device includes a word line and a plurality of memory cells connected to the word line;
the plurality of memory cells forms a page; and
the number of sectors configuring the page and the size of each of the sectors are changed.

13. The memory system as set forth in claim 12, wherein the memory device and the controller configure a solid state drive (SSD).
